(19) United States
(12) Patent Application Publication
(10) Pub. No.: US 2020/0184836 A1
(43) Pub. Date: Jun. 11, 2020

(54) ADS-B RECEIVER-BASED FLIGHT CONTROL METHOD FOR UNMANNED AERIAL VEHICLE, UNMANNED AERIAL VEHICLE, AND CONTROL TERMINAL

(71) Applicant: SZ DJI TECHNOLOGY CO., LTD., Shenzhen (CN)

(72) Inventors: Liangliang YANG, Shenzhen (CN); Ming CHEN, Shenzhen (CN); Naibo WANG, Shenzhen (CN); Zhipeng ZHANG, Shenzhen (CN)

(21) Appl. No.: 16/789,620

(22) Filed: Feb. 13, 2020

Related U.S. Application Data
(63) Continuation of application No. PCT/CN2017/097460, filed on Aug. 15, 2017.

(51) Int. Cl. G08G 5/04; G08G 5/00; B64C 39/02

(52) U.S. Cl. CPC G08G 5/04; G08G 5/0069; B64C 39/024; G08G 5/0008; G08G 5/0078

(57) ABSTRACT

A method for controlling an unmanned aerial vehicle (UAV) includes obtaining flight status information of an aircraft detected by an automatic dependent surveillance-broadcast (ADS-B) receiver carried by the UAV, obtaining flight status information of the UAV, and controlling a flight status of the UAV according to the flight status information of the aircraft and the flight status information of the UAV.

### CROSS-REFERENCE TO RELATED APPLICATION

This application is a continuation of International Application No. PCT/CN2017/097460, filed Aug. 15, 2017, the entire content of which is incorporated herein by reference.

### TECHNICAL FIELD

The present disclosure relates to control technology field, more particularly, to an unmanned aerial vehicle (UAV) flight control method based on an ADS-B receiver, a UAV, and a control terminal.

### BACKGROUND

With a rapid development and popularization of UAVs, more and more UAV users have used UAVs without professional training, posing a huge threat to flight safety of manned aircrafts in the public air space. Manned aircrafts cannot actively avoid a UAV due to restrictions in mobility and flight safety. Thus, the UAV should detect in real time, send early warning, and execute active avoidance to improve the flight safety.

### SUMMARY

In accordance with the disclosure, there is provided a method for controlling an unmanned aerial vehicle (UAV) including obtaining flight status information of an aircraft, obtaining flight status information of the UAV, and controlling a flight status of the UAV according to the flight status information of the aircraft and the flight status information of the UAV. The flight status information of the aircraft is detected by an automatic dependent surveillance-broadcast (ADS-B) receiver carried by the UAV.

Also in accordance with the disclosure, there is provided an unmanned aerial vehicle (UAV) control method including obtaining flight status information of a UAV and flight status information of an aircraft, and controlling a flight status of the UAV according to the flight status information of the aircraft and the flight status information of the UAV. The flight status information of the aircraft is detected by an automatic dependent surveillance-broadcast (ADS-B) receiver carried by the UAV.

Also in accordance with the disclosure, there is provided an unmanned aerial vehicle (UAV) including a memory storing instructions and a processor. The processor is configured to read the instructions from the memory to obtain flight status information of an aircraft, obtain flight status information of the UAV, and control a flight status of the UAV according to the flight status information of the aircraft and the flight status information of the UAV. The flight status information of the aircraft is detected by an ADS-B receiver carried by the UAV.

The present disclosure provides a technical solution that the flight status information of the UAV is obtained according to the flight status information of at least one aircraft detected by the ADS-B receiver carried by the UAV and a flight status of the UAV is controlled according to the flight status information of the at least one aircraft and the flight status of the UAV. The nearby aircrafts can be detected in real time and the flight status of the UAV can be controlled actively and in time to improve the flight safety.

### BRIEF DESCRIPTION OF THE DRAWINGS

FIG. 1 is a schematic flowchart of a UAV flight control method based on an ADS-B receiver according to an example embodiment of the disclosure.

FIG. 2 is a schematic structural diagram of a UAV based on an ADS-B receiver according to an example embodiment of the disclosure.

FIG. 3 is a schematic flowchart showing a calculation for flight time according to an example embodiment of the disclosure.

FIG. 4 is a schematic flowchart showing a calculation for flight trajectory intersections according to an example embodiment of the disclosure.

FIG. 5 is a schematic flowchart of a UAV flight control method based on an ADS-B receiver according to an example embodiment of the disclosure.

FIG. 6 is a schematic flowchart of a UAV flight control method based on an ADS-B receiver according to an example embodiment of the disclosure.

FIG. 7 is a schematic theoretical diagram of a safe distance according to an example embodiment of the disclosure.

FIG. 8 is a schematic structural diagram of a wireless receiving device according to an example embodiment of the disclosure.

FIG. 9 is a schematic structural diagram of a control terminal according to an example embodiment of the disclosure.

### DETAILED DESCRIPTION OF THE EMBODIMENTS

Technical solutions of the present disclosure will be described with reference to the drawings. The described embodiments are only some of the embodiments not all the embodiments of the present disclosure. Based on the embodiments of the disclosure, all other embodiments obtained by those of ordinary skill in the art without any creative work are within the scope of the present disclosure.

To ensure a safe flight, the present disclosure provides an unmanned aerial vehicle (UAV) flight control method based on an automatic dependent surveillance-Broadcast (ADS-B) receiver. The receiver obtains flight status information of nearby aircrafts the UAV through the ADS-B receiver carried by the UAV and obtains flight status information of the UAV. The flight status of the UAV is controlled according to the flight status information of the aircrafts and the flight status information of the UAV. Nearby aircrafts can be detected in real time by the ADS-B receiver carried by the UAV and the flight status of the UAV can be controlled actively and in time to improve the flight safety.

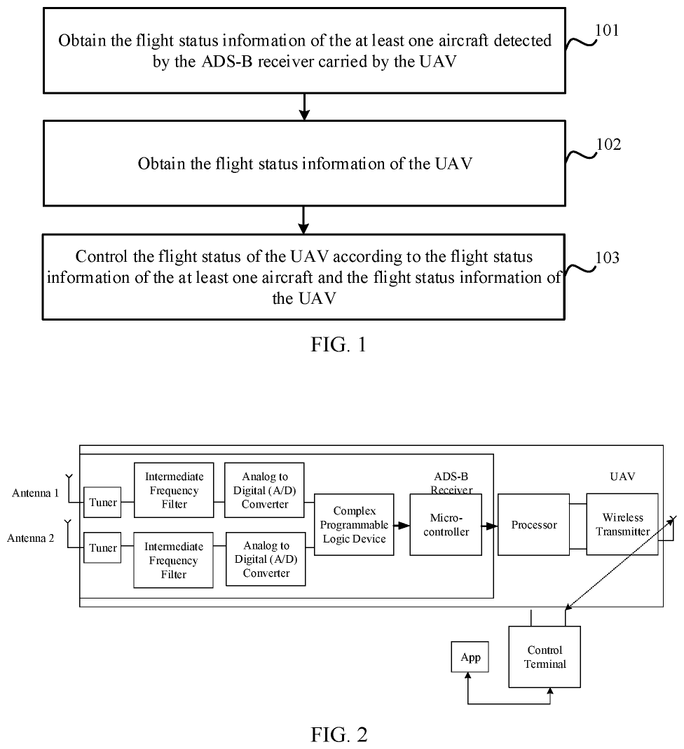

A method consistent with the disclosure will be described below with reference to FIG. 1.

FIG. 1 is a schematic flowchart of an unmanned aerial vehicle (UAV) flight control method based on an ADS-B receiver according to an example embodiment of the disclosure. As shown in FIG. 1, at 101, the flight status information of at least one aircraft detected by the ADS-B receiver carried by the UAV is obtained.

In the embodiment, the ADS-B receiver carried by the UAV can detect the flight status information sent by an ADS-B transmitter carried by the at least one aircraft.

In the embodiment, the flight status information includes at least one of position information, altitude information, speed information, direction information, or an identification number. In this disclosure, the flight status information is not restricted.

At 102, the flight status information of the UAV is obtained.

In the embodiment, the flight status information of the UAV can be obtained from a storage device of the UAV. The flight status information includes at least one of position information, altitude information, speed information, direction information, or an identification number. In this embodiment, the flight status information is not restricted.

The order of the processes of 101 and 102 can be interchanged in the embodiment. For example, the processes of 101 and 102 can be executed at the same time, or the process of 101 can be executed after the process of 102. The execution order can be set according to specific scenarios, which is not restricted in the disclosure.

At 103, the flight status of the UAV is controlled according to the flight status information of the at least one aircraft and the flight status information of the UAV.

In the embodiment, the flight status of the UAV can include a normal status, an early-warning status, or an avoidance status. The normal status refers to a status in which the UAV will not collide with any of the at least one aircraft and can continue to fly according to the present flight status. The early-warning status refers to a status in which the UAV can possibly collide with one of the at least one aircraft, but the collision probability is relatively small, and the UAV can continue to fly according to the present flight status while staying alert. The avoidance status refers to a status in which the probability of collision between the UAV and one of at least one the aircraft is relatively large, and the UAV needs to avoid. In some embodiments, more or less flight statuses can be set according to the specific scenarios, which is not specifically restricted in the disclosure.

In the embodiment, the flight status of the UAV can be controlled according to the flight status information of the at least one aircraft and the flight status information of the UAV described above because, if the UAV is close to a nearby aircraft or is at a flight trajectory of another aircraft, the UAV may affect the flight safety of that aircraft and the flight safety of the UAV itself. Thus, the flight status of the UAV can be controlled according to the flight status information of respective aircrafts and the flight status information of the UAV to adjust the distance between the UAV and the other aircrafts or to control the UAV to fly away from the trajectory of the other aircrafts, so as not to affect the flight safety of the other aircrafts.

As shown in FIG. 2, the UAV carries a two-band ADS-B receiver and is equipped with a processor and a wireless transmission circuit. The ADS-B receiver includes antenna 1 and a tuner, an intermediate frequency filter, and an analog to digital (A/D) converter corresponding to antenna 1, antenna 2 and a tuner, an intermediate frequency filter and an A/D converter corresponding to antenna 2, a complex programmable logic device, and a microcontroller. Antenna 1 and antenna 2 work in the bands of 1090 MHz and 978 MHz, respectively, and both of the antennas have the same working principle. Antenna 1 receives radio frequency (RF) signals. The corresponding tuner selects a desired RF signal from the received RF signals through the resonance of the tuner. The carrier frequency of the selected RF signal is reduced by the corresponding intermediate frequency filter. The RF signal is converted to digital baseband signal by the A/D converter and sent to the complex programmable logic device. The complex programmable logic device inspects synchronously and demodulate the ADS-B baseband signal, generates ADS-B raw binary data, and sends to the microcontroller. The microcontroller decodes the ADS-B raw binary data to generate the flight status information of the at least one aircraft and send the flight status information of the at least one aircraft to the processor, which finally communicates with the wireless transmission circuit according to the processing results.

In the embodiment of the disclosure, ADS-B receiver carried by the UAV can detect the nearby aircrafts and determine the flight status of the aircrafts, and the UAV can also control the UAV flight status actively and in time to avoid collisions with the nearby aircrafts and improve the flight safety.

In one embodiment of the disclosure, the ADS-B receiver carried by the UAV can receive the flight status information of the at least one aircraft according to the preset frequency. The UAV can know the flight status information of each aircraft in time.

In actual flight, the distances of the UAV from the individual nearby aircrafts are different. The distances include horizontal distances and/or height differences. If the distance between the UAV and the aircraft is far, the probability of the collision between them is far less than the probability of the collision with the aircraft with shorter distance. Thus, in one embodiment of the disclosure, the ADS-B receiver carried by the UAV can receive the flight status information of the at least one aircraft according to different frequencies. Based on the above principles, a receiving frequency for the ADS-B receiver to receive the flight status information of the at least one aircraft can be adjusted according to the distance between the UAV and the at least one aircraft. The receiving frequency characterizes how often the UAV receives the flight status information from the at least one aircraft. In the embodiment, the receiving frequency can be negatively correlated with the distance between the UAV and the aircraft, i.e., as the distance increases, the receiving frequency decreases. For example, if the distance is short (tens of kilometers), the receiving frequency can be 2 Hz (i.e., receives the flight status of the aircraft twice every second), and if the distance is long (hundreds of kilometers), the receiving frequency can be 0.5 Hz (i.e., receives the flight status of the aircraft once every two seconds).

The ADS-B receiver can preferentially receive the flight status information of the aircrafts with shorter distances, and accurately determine the relationship between the positions of the UAV and each aircraft or the relationship between the UAV and the trajectory of each aircraft. As such, only bandwidth is saved and data processing is reduced, but also the flight status of the UAV can be controlled in time to avoid collision with other aircraft and improve flight safety.

The distance between the UAV and the at least one aircraft can be determined according to the position information in the flight status information. For example, the distance between the UAV and a first aircraft can be calculated according to the position information in the flight status information of the UAV and the position information in the flight status information of the first aircraft. The first aircraft can be any one of the at least one aircraft. The position information in the flight status information is obtained by positioning devices of the UAV and the first aircraft. The resolution can be below decimeter and the accuracy is high. Thus, the accuracy of the distance between the UAV and the first aircraft is high.

The positioning device mentioned above can be one or more of GNSS (Global Navigation Satellite System) receiver, GPS (Global Positioning System) receiver, BeiDou Navigation Satellite System receiver, Galileo Satellite Navigation System receiver, and GLONASS receiver. It is not restricted in the disclosure.

In one embodiment of the disclosure, to improve the communication range of the ADS-B receiver, the ADS-B receiver operates in the 1090 MHz and/or 978 MHz frequency bands. Correspondingly, the ADS-B receiver is provided with two dual-frequency (1090 MHz/978 MHz) receiving antennas, so that the ADS-B receiver can communicate with ADS-B transmitter individually using 1090 MHz or 978 MHz.

In one embodiment of the disclosure, to save power, the ADS-B receiver determines the standard frequency band of the area according to the flight position of the UAV, and then works only with the standard frequency band. For example, when the UAV is in flight in China, it can use the 1090 MHz frequency band, when the UAV is in flight in the U.S., it can use the 1090 MHz and/or 978 MHz frequency bands.

In one embodiment of the disclosure, to facilitate accident investigation and analysis, the UAV is set with a log. The log is configured to record the flight status information of the UAV. The accident can be investigated according to the log records after the collision between the UAV and a nearby aircraft.

In practical applications, the ADS-B receiver also includes functions such as watchdog, heartbeat detection, and security authentication. Hardware interfaces, such as USB, CAN, UART, can be set between the microcontroller and the processor for convenient upgrade of software in the UAV, and it will not be described in detail here.

In one embodiment of the disclosure, controlling the flight status of the UAV according to the flight status information of the at least one aircraft and the flight status information of the UAV includes determining a collision risk factor of the UAV and the first aircraft according to the flight status information of the first aircraft and the flight status information of the UAV.

The collision risk factor can include at least one of a flight time of the aircraft, or a flight radius or safe distance of the UAV.

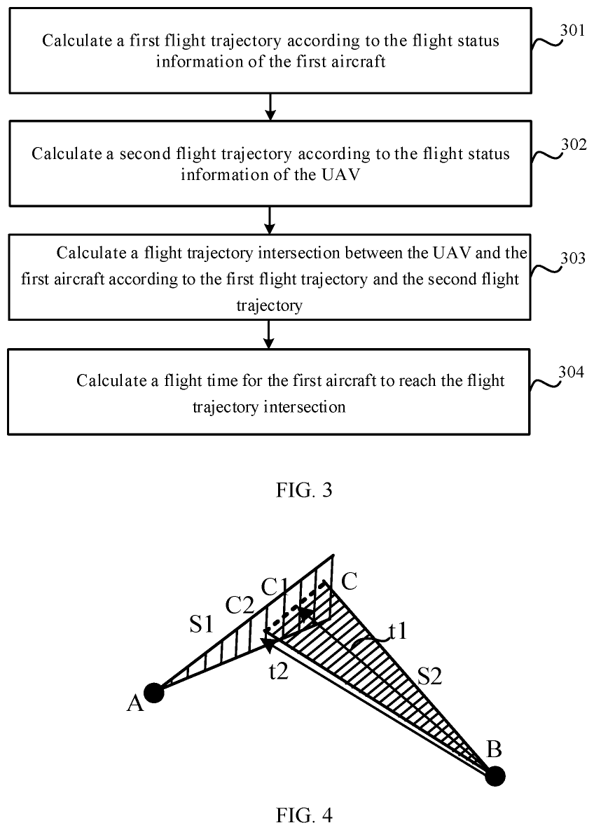

In one embodiment, the collision risk factor includes the flight time of the aircraft, and determining the collision risk factor of the UAV and the first aircraft according to the flight status information of the first aircraft and the flight status information of the UAV can include the processes described below with reference to FIG. 3.

At 301, a first trajectory is calculated according to the flight status information of the first aircraft.

In the embodiment, the first flight trajectory that the first aircraft has traversed can be obtained according to the speed information, the direction information, the position information, the altitude information, etc., in the flight status information, and the predicted first flight trajectory of the first aircraft that is predicted follows the current position of the first aircraft. Due to the deviation (or direction transition radius) in the flight of the first aircraft, the first trajectory of the first aircraft above can be a sectoral area, the range of which can be far larger than the actual trajectory of the first aircraft. In the embodiment, the distance between the UAV and the first aircraft can be limited by appropriately increasing the first trajectory of the first aircraft, i.e., the collision event can be predicted in advance.

In some embodiments, the flight status information of the aircraft includes the first flight trajectory of the aircraft, which can be used directly.

At 302, a second flight trajectory is calculated according to the flight status information of the UAV.

In the embodiment, the second trajectory of the UAV is obtained according to the speed information, the direction information, the position information, the altitude information, etc., in the flight status information of the UAV. In some embodiments, the flight status information of the UAV includes the second flight trajectory of the UAV, which can be used directly.

At 303, a flight trajectory intersection between the UAV and the first aircraft is calculated according to the first flight trajectory and the second flight trajectory.

In the embodiment, the flight trajectory intersection of the first flight trajectory and the second flight trajectory is calculated according to a geometric method.

If there is a mathematical solution, it means there is a flight trajectory intersection. Since the first flight trajectory and the second flight trajectory are sectoral areas, there may be several flight trajectory intersections. As shown in FIG. 4, the first flight trajectory of the first aircraft B is S1, the second flight trajectory of the UAV A is S2, then the flight trajectory intersection of the first flight trajectory S1 and the second flight trajectory S2 is C.

If there is no mathematical solution, it means there is no flight trajectory intersection.

At 304, a flight time for the first aircraft to reach the flight trajectory intersection is calculated.

In the embodiment, the flight time for the first aircraft to reach the flight trajectory intersection is calculated according to the speed information and the direction information of the first aircraft. As shown in FIG. 4, the flight time for the first aircraft to the flight trajectory intersection C1 (the shortest distance from the flight trajectory intersection C to the first aircraft) is t1, the time for the first aircraft to reach the flight trajectory intersection C2 (the boundary point of the flight trajectory intersection C, which is closest to the UAV) is t2, and the smallest one of the above times is used as the flight time.

In the embodiment, through the calculation of the flight time for the first aircraft to reach the flight trajectory intersection, the collision time between the UAV and the first aircraft, or a response time reserved for the UAV to avoid the collision event, can be predicted. Hence, the UAV can determine the flight status according to the flight time to avoid collision, and hence the flight safety is improved.

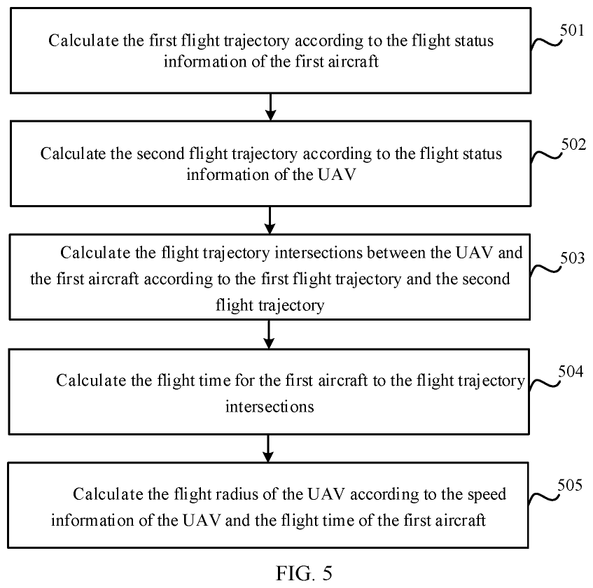

In another embodiment, the collision risk factor includes the flight time of the aircraft, and determining the collision risk factor of the UAV and the first aircraft according to the flight status information of the first aircraft and the flight status information of the UAV can include the processes described below with reference to FIG. 5.

At 501, the first flight trajectory is calculated according to the flight status information of the first aircraft.

The processes of 501 and 301 have the same specific methods and principles. For details about the process of 501, reference can be made to the related content of FIGS. 3 and 301, and details are not described herein again.

At 502, the second flight trajectory is calculated according to the flight status information of the UAV.

The processes of 502 and 302 have the same specific methods and principles. For details about the process of 502, reference can be made to the related content of FIGS. 3 and 302, and details are not described herein again.

At 503, the flight trajectory intersections between the UAV and the first aircraft are calculated according to the first flight trajectory and the second flight trajectory.

The processes of 503 and 303 have the same specific methods and principles. For details of 503, reference can be made to the related content of FIGS. 3 and 303, and details are not described herein again.

At 504, the flight time is calculated for the first aircraft to the flight trajectory intersections.

The processes of 504 and 304 have the same specific methods and principles. For details of 504, reference can be made to the related content of FIGS. 3 and 304 and details are not described herein again.

At 505, the flight radius of the UAV is calculated according to the speed information of the UAV and the flight time of the first aircraft.

In the embodiment, the speed information is obtained from the flight status information of the UAV, then the flight radius R of the UAV is calculated according to the speed information and the flight time of the first aircraft.

For example, the flight radius R of the UAV is 10 kilometers, the flight radius of the first aircraft is 20 kilometers. If the distance between the first aircraft and the UAV is less than 30 kilometers, the collision risk is high, and early warning or avoidance should be carried out. If the distance between the first aircraft and the UAV is larger than 30 kilometers, the collision risk is low, and the flight status of the UAV can be continued. If the distance between the UAV and the first aircraft is close to 30 kilometers, the UAV perform early warning.

In one embodiment, to reduce the calculation load of the UAV, the flight radius of the UAV can be pre-configured. For example, the flight radius of the UAV is 10 kilometers, the flight radius of the first aircraft is 20 kilometers. If the distance between the first aircraft and the UAV is less than 30 kilometers, the collision risk is high, and early warning or avoidance should be carried out. If the distance between the first aircraft and the UAV is larger than 30 kilometers, the collision risk is low, and the flight status of the UAV can be continued. If the distance between the UAV and the first aircraft is close to 30 kilometers, the UAV sends early warnings. Pre-configuring flight radius in the UAV can also realize the solution of the embodiment.

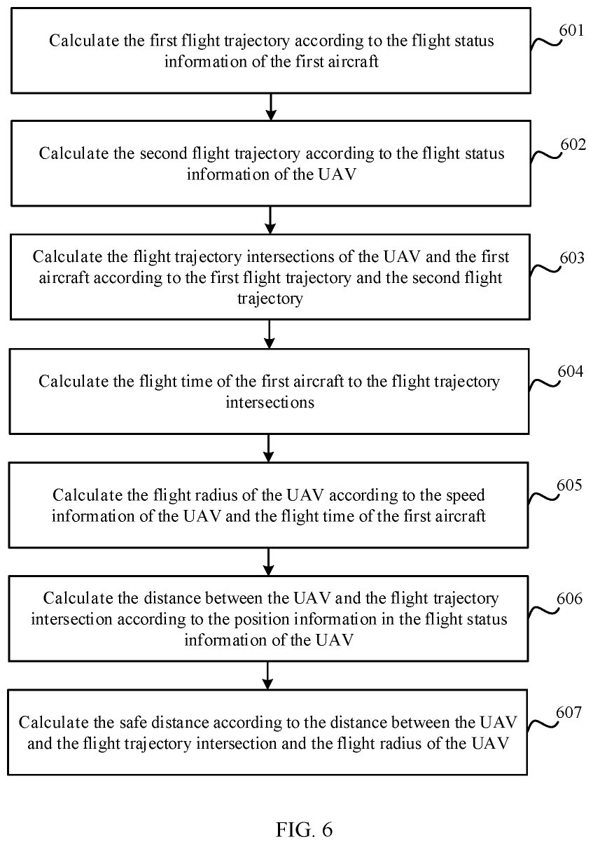

In another embodiment, the collision risk factor includes the safe distance, and determining the collision risk factor of the UAV and the first aircraft according to the flight status information of the first aircraft and the UAV can include the processes described below with reference to FIG. 6.

At 601, the first flight trajectory is calculated according to the flight status information of the first aircraft.

The processes of 601 and 301 have the same specific methods and principles. For details of 601, reference can be made to the related content of FIGS. 3 and 301, and details are not described herein again.

At 602, the second flight trajectory is calculated according to the flight status information of the UAV.

The processes of 602 and 302 have the same specific methods and principles. For details of 602, reference can be made to the related content of FIGS. 3 and 302, and details are not described herein again.

At 603, the flight trajectory intersections of the UAV and the first aircraft are calculated according to the first flight trajectory and the second flight trajectory.

The processes of 603 and 303 have the same specific methods and principles. For details of 603, reference can be made to the related content of FIGS. 3 and 303, and details are not described herein again.

At 604, the flight time of the first aircraft to the flight trajectory intersections is calculated.

The processes of 604 and 304 have the same specific methods and principles. For details of 604, reference can be made to the related content of FIGS. 3 and 304, and details are not described herein again.

At 605, the flight radius of the UAV is calculated according to the speed information of the UAV and the flight time of the first aircraft.

The processes of 605 and 504 have the same specific methods and principles. For details of 605, reference can be made to the related content of FIGS. 5 and 504, and details are not described herein again.

At 606, the distance between the UAV and the flight trajectory intersection is calculated according to the position information in the flight status information of the UAV.

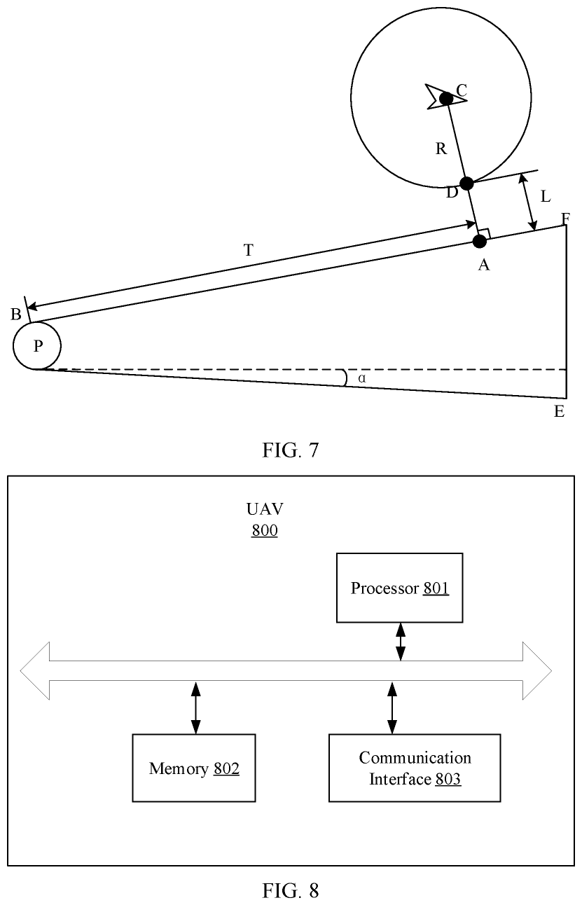

In the embodiment, the position information of the flight status information of the UAV is obtained, then the distance between the UAV and the flight trajectory intersection is calculated according to the position information and the flight trajectory intersection. As shown in FIG. 7, the position of the UAV is C, the flight trajectory intersection is A, then the distance between the two points is AC.

At 607, the safe distance is calculated according to the distance between the UAV and the flight trajectory intersection and the flight radius of the UAV.

In the embodiment, after the distance between the UAV and the flight trajectory intersection is obtained, the safe distance can be obtained based on the flight radius of the UAV. As shown in FIG. 7, the flight radius of the UAV is R, the distance between the UAV and the flight trajectory intersection is AV, then the safe distance L is AC-R.

If the safe distance L is longer than a safe distance threshold, the collision risk is low or 0, and the UAV can maintain the current flight status. If the safe distance L is shorter than or equal to the safe distance threshold, the collision risk is high, and the UAV can carry out early warning or avoidance. Assume that the safe distance threshold is 10 kilometers, the flight radius R of the UAV is 20 kilometers. If the distance between the UAV and the flight trajectory intersection, AC, is longer than 30 kilometers, then the safe distance is longer than 10 kilometers (i.e., longer than the safe distance threshold). In this scenario, the collision risk is low, and the UAV can continue with the current flight status. If AC is shorter than or equal to 30 kilometers, then the safe distance is shorter than or equal to 10 kilometers (i.e., shorter than or equal to the safe distance threshold). In this scenario, the collision risk is high, and the UAV can carry out early warning or avoidance.

In the embodiments described above, the collision risk factor is the flight time of the aircraft, the flight radius of the UAV, or the safe distance, and the collision risk factor can be configured to qualitatively analyze the risk of collision of the UAV. To implement a more detailed control and obtain a better control effect, the collision risk factor can be calculated according to the flight time of the aircraft, the flight radius of the UAV, or the safe distance in the embodiment of the disclosure, and the collision risk factor can be related to the flight time, the flight radius, or the safe distance.

Take the flight radius as an example. The safe distance can be set to 50 kilometers, and the corresponding collision risk factor is 0. 40-50 kilometers can be set as a relatively-safe distance, and the corresponding collision risk factor is 0-0.3. 30-40 kilometers can be set as the distance for early warning, and the corresponding collision risk factor is 0.3-0.5. 20-30 kilometers can be set as a dangerous distance, and the corresponding collision risk factor is 0.5-0.7. A distance shorter than 20 kilometers can be set as an avoidance distance, and the corresponding collision risk factor is 0.7-1.0. Take the flight time as another example. The safe flight time is longer than 3 minutes, and the corresponding collision risk factor is 0-0.3. 2-3 minutes can be set as flight time for early warning, and the corresponding collision risk factor is 0.3-0.5. 1-2 minutes can be set as a dangerous flight time, and the corresponding collision risk factor is 0.5-0.7. A flight time shorter than 1 minute can be set as an avoidance flight time, and the corresponding collision risk factor is 0.7-1.0.

In some embodiments, after the collision risk factor is determined, the flight status of the UAV can be adjusted according to the collision risk factor.

If the collision risk factor is less than 0.5, the UAV can be controlled to maintain the normal status according to the current flight mode of the UAV, and the details are not described here.

If the collision risk factor is larger than 0.5 but less than 0.7, the UAV can be controlled to enter the early warning status, generate the early warning, and send the early warning to a control terminal. In some embodiments, the UAV also sends the collision risk factor to the control terminal. In some embodiments, the UAV determines an early warning level according to the collision risk factor, generates a corresponding early warning message according to the early warning level, and sends the early warning message to the control terminal. As such, the user can know the risk in time and risk awareness is improved.

If the collision risk factor is larger than 0.7, the UAV is controlled to enter the avoidance status.

Controlling the flight status of the UAV according to the collision risk factor can avoid frequent switching of the UAV between different flight statuses that affects user's flight experience.

In one embodiment of the disclosure, to prompt the user in time after receiving the early warning message, the control terminal searches for the corresponding prompting mode to prompt the user. Example prompting modes are described below.

Early warning message 1: a text prompt with no flashing that pops up automatically at set timing and disappears when time is up.

Early warning message 2: a text prompt with no flashing that pops up automatically at set timing and does not disappear automatically (only closes when a user clicks).

Early warning message 3: a text prompt with flashing that pops up automatically at set timing and does not disappear automatically (only closes when a user clicks).

Early warning message 4: the control terminal vibrates.

Early warning message 5: the control terminal vibrates and produces a warning sound.

With the different prompting modes, the user can understand the early warning messages in time, improve risk awareness, and adjust the flight status of the UAV in time.

In one embodiment of the disclosure, when the UAV is determined to enter the avoidance status, an avoidance trajectory needs to be obtained for the UAV, and the UAV can be controlled to fly according to the avoidance trajectory. Example methods of obtaining the avoidance trajectory are described below.

In one embodiment, a first direction vector of the UAV and the first aircraft is obtained. The first direction vector is from the head of the UAV to the first aircraft. A reverse direction of the first direction vector can be determined as the avoidance trajectory. In the embodiment, the UAV is controlled to fly in the reverse direction to fly away from the first aircraft to the maximum extend to avoid collision event and improve flight safety.

In one embodiment, a second direction vector of the UAV and the flight trajectory intersection is obtained. The second direction vector is from the head of the UAV to the flight trajectory intersection. A reverse direction of the second direction vector can be determined as an avoidance trajectory. In the embodiment, the UAV is controlled to fly away from the flight trajectory intersection to the maximum extend from the first aircraft before the first aircraft reaches the flight trajectory intersection, so as to avoid collision event and improve flight safety.

In one embodiment, since the flight altitude of the aircrafts, especially manned aircrafts, is higher than the flight altitude of the UAV, the direction of vertically downward is determined as an avoidance trajectory. If the flight trajectory intersection is above the UAV when the UAV flies upwards, the UAV can fly vertically downward to avoid collision events and improve flight safety. The method is simple and easy to implement.

Consistent with the disclosure, one of ordinary skill in the art can determine avoidance trajectory according to specific scenarios for the UAV to avoid the first aircraft with a most appropriate method and improve flight safety. The scenarios and method are not restricted in the embodiment.

When the calculation resource (e.g., memory, processor, etc.) of the UAV is limited, the UAV can send the flight status information of the at least one aircraft and the flight status information of the UAV to the control terminal through the communication link. The control terminal processes the flight status information to obtain the flight status of the UAV. The control terminal generates corresponding control commands according to the flight status of the UAV and sends the control commands to the UAV, so as to control the flight status of the UAV. The flight status information can be processed similarly as described above. The flight status information processing is thus not described in detail in this embodiment.

In accordance with the disclosure, there is also provided a UAV. As shown in FIG. 8, the UAV includes a processor 801, a memory 802, and a communication interface 803. The communication interface 803 is configured to communicatively connect with the control terminal. The memory 802 stores instructions. The processor 801 reads the instructions from the memory 802 to obtain the flight status information of the at least one aircraft detected by the ADS-B receiver carried by the UAV, obtain the flight status information of the UAV, and control the flight status of the UAV according to the flight status information of the at least one aircraft and the flight status information of the UAV.

In one embodiment of the disclosure, the flight status information includes at least one of position information, altitude information, speed information, direction information, or an identification number.

In one embodiment of the disclosure, the flight status of the UAV includes a normal status, an early warning status, or an avoidance status.

In one embodiment of the disclosure, the processor 801 controls the flight status of the UAV according to the flight status information of the at least one aircraft and the flight status information of the UAV by determining the collision risk factor of the UAV and the first aircraft according to the flight status information of the first aircraft and the flight status information of the UAV, and controlling the flight status of the UAV according to the collision risk factor. The at least one aircraft includes the first aircraft.

In one embodiment of the disclosure, if the collision risk factor includes flight time of the aircraft, the processor 801 determines the collision risk factor of the UAV and the first aircraft according to the flight status information of the first aircraft and the UAV by calculating the first flight trajectory according to the flight status information of the first aircraft, calculating the second flight trajectory according to the flight status information of the UAV, calculating the flight trajectory intersection of the UAV and the first aircraft according to the first flight trajectory and the second flight trajectory, and calculating the flight time of the first aircraft to the flight trajectory intersection according to the speed information of the first aircraft.

In one embodiment of the disclosure, if the collision risk factor includes the flight radius of the UAV, the processor 801 determines the collision risk factor of the UAV and the first aircraft according to the flight status information of the first aircraft and the UAV by calculating the flight radius according to the speed information of the UAV and the flight time of the first aircraft.

In one embodiment of the disclosure, if the collision risk factor is the safe distance, the processor 801 determines the collision risk factor of the UAV and the first aircraft according to the flight status information of the first aircraft and the flight status information of the UAV by calculating the distance of the UAV to the flight trajectory intersection according to the position information in the flight status information of the UAV, and calculating the safe distance according to the distance of the UAV to the flight trajectory intersection and the flight radius of the UAV.

In one embodiment of the disclosure, the processor 801 obtains the flight status information of the at least one aircraft detected by the ADS-B receiver carried by the UAV. The flight status information of the at least one aircraft is received by the ADS-B receiver according to the preset frequency.

In one embodiment of the disclosure, the processor 801 obtains the flight status information of the at least one aircraft detected by the ADS-B receiver carried by the UAV. The flight status information of the at least one aircraft is received by the ADS-B receiver according to different frequencies.

In one embodiment of the disclosure, the processor 801 obtains the flight status information of the at least one aircraft received by the ADS-B receiver according to different frequencies. The frequency for the ADS-B receiver to receive the flight status information of the at least one aircraft is adjusted according to the distance between the UAV and the at least one aircraft.

In one embodiment of the disclosure, the processor 801 reads instructions from the memory to obtain the position information in the flight status information of the first aircraft and the position information in the flight status information of the UAV, and calculate the distance between the UAV and the first aircraft according to the position information of the aircraft and the flight status information of the UAV.

In one embodiment of the disclosure, the distance between the UAV and the at least one aircraft includes horizontal distance and/or altitude difference.

In one embodiment of the disclosure, the processor 801 adjusts the frequency for the ADS-B receiver to receive the flight status information of the at least one aircraft according to the distance between the UAV and the at least one aircraft. The frequency is negatively correlated with the distance.

In one embodiment of the disclosure, the ADS-B receiver works in the frequency band of 1090 MHz and/or the frequency band of 978 MHz.

In one embodiment of the disclosure, the processor 801 determines the flight status of the UAV as the avoidance status. In this embodiment, the processor 801 further obtains an avoidance trajectory and controls the UAV to fly according to the avoidance trajectory.

In one embodiment of the disclosure, the processor 801 obtains an avoidance trajectory by obtaining the first direction vector of the UAV and the first aircraft, and determining the reverse direction of the first direction vector as the avoidance trajectory. The first direction vector indicates the direction from the head of the UAV to the first aircraft.

In one embodiment of the disclosure, the processor 801 obtains an avoidance trajectory by obtaining the second direction vector of the UAV and the flight trajectory intersection and determining the reverse direction of the second direction vector as the avoidance trajectory. The second direction vector indicates the direction from the head of the UAV to the flight trajectory intersection.

In one embodiment of the disclosure, the processor 801 obtains an avoidance trajectory by determining the vertically downward direction as the avoidance trajectory.

In one embodiment of the disclosure, the processor 801 determines the flight status of the UAV as the avoidance status. In this embodiment, the processor 801 generates an avoidance message and sends the avoidance message to the control terminal through the communication interface 803.

In one embodiment of the disclosure, the processor 801 determines the flight status of the UAV is the early warning status. In this embodiment, the processor 801 sends a collision risk factor to the control terminal through the communication interface 803.

In one embodiment of the disclosure, the processor 801 determines the flight status of the UAV is the early warning status. In this embodiment, the processor 801 generates an early warning message and sends the early warning message to the control terminal through the communication interface 803.

In one embodiment of the disclosure, the processor 801 generates the early warning message and sends the early warning message to the control terminal through the communication interface 803 by determining the early warning level according to the collision risk factor, generating the early warning message according to the early warning level, and sending the early warning message to the control terminal through the communication interface 803.

In one embodiment of the disclosure, the processor 801 reads instructions from the memory 802 to obtain the control commands from the control terminal through the communication interface 803 and control the flight status of the UAV according to the control commands.

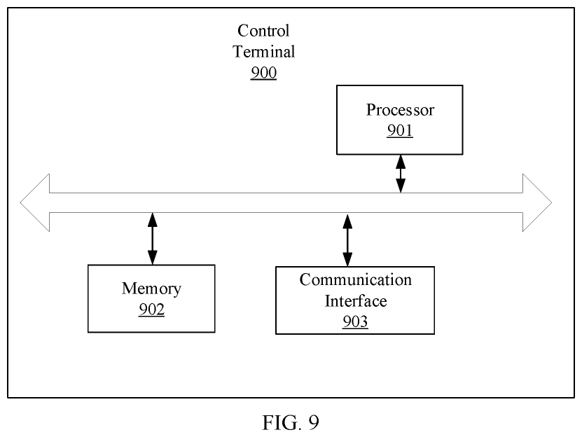

In accordance with the disclosure, there is also provided a control terminal. As shown in FIG. 9, the control terminal includes a processor 901, a memory 902, and a communication interface 903. The communication interface 903 is configured to communicatively connect to the UAV, the memory 902 stores instructions, and the processor 901 reads the instructions from the memory 902 to obtain, through the communication interface 903, the flight status information of the UAV and the flight status information of the at least one aircraft detected by the ADS-B receiver carried by the UAV, and control the flight status of the UAV according to the flight status information of the at least one aircraft and the flight status information of the UAV.

In one embodiment of the disclosure, the flight status information includes at least one of position information, altitude information, speed information, direction information, or an identification number.

In one embodiment of the disclosure, the flight status of the UAV includes the normal status, the early warning status, or the avoidance status.

In one embodiment of the disclosure, the processor 901 controls the flight status of the UAV according to the flight status information of the at least one aircraft and the flight status information of the UAV by determining the collision risk factor of the UAV and the first aircraft according to the flight status information of the first aircraft and the UAV, and controlling the flight status of the UAV according to the collision risk factor. The at least one aircraft includes the first aircraft.

In one embodiment of the disclosure, if the collision risk factor includes the flight time of the aircraft, the processor 901 determines the collision risk factor of the UAV and the first aircraft according to the flight status information of the first aircraft and the UAV by calculating the first flight trajectory according to the flight status information of the first aircraft, calculating the second flight trajectory according to the flight status information of the UAV, calculating the flight trajectory intersection of the UAV and the first aircraft according to the first trajectory and the second flight trajectory, and calculating the flight time of the first aircraft to the flight trajectory intersection according to the speed information of the first aircraft.

In one embodiment of the disclosure, if the collision risk factor includes the flight radius of the UAV, the processor 901 determines the collision risk factor of the UAV and the first aircraft according to the flight status information of the first aircraft and the UAV by calculating the flight radius of the UAV according to the speed information of the UAV and the flight time of the first aircraft.

In one embodiment of the disclosure, if the collision risk factor is the safe distance, the processor 901 determines the collision risk factor of the UAV and the first aircraft according to the flight status information of the first aircraft and the UAV by calculating the distance of the UAV to the flight trajectory intersection according to the position information in the flight status information of the UAV, and calculating the safe distance according to the distance of the UAV to the flight trajectory intersection and the flight radius of the UAV.

In one embodiment of the disclosure, the processor 901 obtains the flight status information of the at least one aircraft detected by the ADS-B receiver carried by the UAV. The processor 901 receives the flight status information of the at least one aircraft from the ADS-B receiver according to different frequencies.

In one embodiment of the disclosure, the processor 901 receives the flight status information of the at least one aircraft from the ADS-B receiver according to different frequencies by adjusting the frequency for the ADS-B receiver to receive the flight status information of the at least one aircraft according to the distance between the UAV and the at least one aircraft.

In one embodiment of the disclosure, the processor 901 reads instructions from the memory 902 to obtain the position information in the flight status information of the first aircraft and the position information of the flight status information of the UAV, and calculate the distance between the UAV and the first aircraft according to the position information of the aircraft and the UAV.

In one embodiment of the disclosure, the distance between the UAV and the at least one aircraft includes the vertical distance and/or altitude difference.

In one embodiment of the disclosure, the processor 901 adjusts the frequency for the ADS-B receiver to receive the flight status information of the at least one aircraft according to the distance between the UAV and the at least one aircraft, and the frequency is negatively correlated with the distance.

In one embodiment of the disclosure, the ADS-B receiver works in the frequency band of 1090 MHz and/or the frequency band of 978 MHz.

In one embodiment of the disclosure, the processor 901 determines the flight status of the UAV as the avoidance status. In this embodiment, the processor 901 further obtains an avoidance trajectory and controls the UAV to fly according to the avoidance trajectory.

In one embodiment of the disclosure, the processor 901 obtains an avoidance trajectory by obtaining the first direction vector of the UAV and the first aircraft and determining the reverse direction of the first direction vector as the avoidance trajectory. The first direction vector indicates the direction from the head of the UAV to the first aircraft.

In one embodiment of the disclosure, the processor 901 obtains an avoidance trajectory by obtaining the second direction vector of the UAV and the flight trajectory intersection and determining the reverse direction of the second direction vector as the avoidance trajectory. The second direction vector indicates the direction from the head of the UAV to the flight trajectory intersection.

In one embodiment of the disclosure, the processor 901 obtains an avoidance trajectory by determining the vertical downward as the avoidance trajectory.

In one embodiment of the disclosure, when determining the flight status as the avoidance status. In this embodiment, the processor 901 generates avoidance commands and sends the avoidance commands to the UAV through the communication interface 903.

In one embodiment of the disclosure, the processor 901 determines the flight status is the early warning status. In this embodiment, the collision risk factor to the UAV to determine the early warning level according to the collision risk factor.

In one embodiment of the disclosure, the processor 901 determines the flight status is the early warning status. In this embodiment, the processor 901 generates an early warning message and sends the early warning commands to the UAV through the communication interface 903.

In another embodiment of the disclosure, there is provided a computer-readable storage medium, which is equipped on the UAV. The computer-readable storage medium stores multiple computer instructions. The computer instructions are executed to obtain the flight status information of the at least one aircraft detected by the ADS-B receiver carried by the UAV, obtain the flight status information of the UAV, and control the flight status of the UAV according to the flight status information of the at least one aircraft and the UAV.

In another embodiment of the disclosure, there is provided a computer-readable storage medium, which is equipped on the control terminal, the machine-readable storage medium stores multiple computer instructions. The computer instructions are executed to obtain the flight status information of the UAV and the flight status information of the at least one aircraft detected by the ADS-B receiver carried by the UAV, and control the flight status of the UAV according to the flight status information of the first aircraft and the UAV.

The embodiments of the disclosure, the devices and methods disclosed can be implemented in other forms. For example, the device embodiments described above are merely illustrative. For example, the division of the units is only a logical function division, and the actual implementation may be according to another division method. For example, multiple units or components can be combined or integrated in another system, or some features can be omitted or not be executed. Further, the displayed or discussed mutual coupling or direct coupling or communicative connection can be through some interfaces, the indirect coupling or communicative connection of the devices or units can be electronically, mechanically, or in other forms.

The units described as separate instructions may be or may not be physically separated, the components displayed as units may be or may not be physical units, which can be in one place or be distributed to multiple network units. Some or all of the units can be chosen to implement the purpose of the embodiment according to the actual needs.

In addition, in the embodiment of the disclosure, individual functional units can be integrated in one processing unit, or can be individual units physically separated, or two or more units can be integrated in one unit. The integrated units above can be implemented by hardware or can be implemented by hardware and software functional units.

The integrated units implemented by software functional units can be stored in a computer-readable storage medium. The above software functional units stored in a storage medium includes multiple instructions for a computing device (such as a personal computer, a server, or network device, etc.) or a processor to execute some of the operations in the embodiments of the disclosure. The storage medium includes USB drive, mobile hard disk, read-only memory (ROM), random access memory (RAM), disk or optical disk, or another medium that can store program codes.

Those of ordinary skilled in the art can understand that, for convenient and simple description, the division of individual functional units are described as an example. In actual applications, the functions above can be assigned to different functional units for implementation, i.e., the internal structure of the device can be divided into different functional units to implement all or some of the functions described above. For the specific operation process of the device described above, reference can be to the corresponding process in the method embodiments, which will not be described in detail here.

The individual embodiments are merely used to describe the technical solution of the disclosure but not used to limit the disclosure. Although the disclosure is described in detail referring to the individual embodiments, one of ordinary skill in the art should understand that it is still possible to modify the technical solutions in the embodiments, or to replace some or all of the technical features. However, these modifications or substitutions do not cause the essence of the corresponding technical solution to depart from the scope of the technical solutions in the individual embodiments of the disclosure.

What is claimed is:

1. A method for controlling an unmanned aerial vehicle (UAV) comprising:
obtaining flight status information of an aircraft detected by an automatic dependent surveillance-broadcast (ADS-B) receiver carried by the UAV;
obtaining flight status information of the UAV; and
controlling a flight status of the UAV according to the flight status information of the aircraft and the flight status information of the UAV.

2. The method of claim 1, wherein:
the flight status information of the aircraft includes at least one of position information, altitude information, speed information, direction information, or an identification number of the aircraft; and
the flight status information of the UAV includes at least one of position information, altitude information, speed information, direction information, or an identification number of the UAV.

3. The method of claim 1, wherein the flight status of the UAV includes a normal status, an early warning status, or an avoidance status.

4. The method of claim 1, wherein controlling the UAV flight status includes:
determining a collision risk factor of the UAV and the aircraft according to the flight status information of the aircraft and the flight status information of the UAV; and
controlling the flight status of the UAV according to the collision risk factor.

5. The method of claim 4, wherein:
the collision risk factor includes a flight time of the aircraft; and
determining the collision risk factor includes:
calculating a first flight trajectory according to the flight status information of the aircraft;
calculating a second flight trajectory according to the flight status information of the UAV;
calculating a flight trajectory intersection of the UAV and the aircraft according to the first flight trajectory and the second flight trajectory; and
calculating the flight time for the aircraft to reach the flight trajectory intersection according to speed information included in the flight status information of the aircraft.

6. The method of claim 4, wherein:
the collision risk factor includes a flight radius of the UAV; and
determining the collision risk factor includes:
calculating a first flight trajectory according to the flight status information of the aircraft;
calculating a second flight trajectory according to the flight status information of the UAV;
calculating a flight trajectory intersection of the UAV and the aircraft according to the first flight trajectory and the second flight trajectory;
calculating a flight time for the aircraft to reach the flight trajectory intersection according to speed information included in the flight status information of the aircraft; and
calculating the flight radius of the UAV according to speed information of the UAV and the flight time of the aircraft.

7. The method of claim 4, wherein:
the collision risk factor includes a safe distance; and
determining the collision risk factor includes:
calculating a first flight trajectory according to the flight status information of the aircraft;
calculating a second flight trajectory according to the flight status information of the UAV;
calculating a flight trajectory intersection of the UAV and the aircraft according to the first flight trajectory and the second flight trajectory;
calculating a flight time for the aircraft to reach the flight trajectory intersection according to speed information included in the flight status information of the aircraft;
calculating a flight radius of the UAV according to speed information of the UAV and the flight time of the aircraft;
calculating a distance from the UAV to the flight trajectory intersection according to position information in the flight status information of the UAV; and
calculating the safe distance according to the distance from the UAV to the flight trajectory intersection and the flight radius of the UAV.

8. The method of claim 1, wherein obtaining the flight status information of the aircraft includes receiving the flight status information of aircraft by the ADS-B receiver according to a pre-set frequency.

9. The method of claim 1, wherein obtaining the flight status information of the aircraft includes receiving the flight status information of the aircraft by the ADS-B receiver according to a frequency that is variable.

10. The method of claim 9, wherein receiving the flight status information of the aircraft includes adjusting the frequency according to a distance between the UAV and the aircraft.

11. The method of claim 10, further comprising, before adjusting the frequency:
obtaining position information in the flight status information of the aircraft and position information in the flight status information of the UAV; and
calculating the distance between the UAV and the aircraft according to the position information of the aircraft and the position information of the UAV.

12. The method of claim 10, wherein the frequency is negatively correlated to the distance.

13. The method of claim 1, wherein controlling the flight status of the UAV includes:
obtaining an avoidance trajectory; and
controlling the UAV to fly according to the avoidance trajectory.

14. The method of claim 13, wherein obtaining the avoidance trajectory includes:
obtaining a direction vector from a head of the UAV to the aircraft; and
determining a reverse direction of the direction vector as the avoidance trajectory.

15. The method of claim 13, wherein obtaining the avoidance trajectory includes determining a vertical downward direction as the avoidance trajectory.

16. The method of claim 1, wherein controlling the flight status of the UAV includes:
controlling the UAV to be in an avoidance status;
generating an avoidance message; and
sending the avoidance message to a control terminal.

17. The method of claim 1, wherein controlling the flight status of the UAV includes:
controlling the UAV to be in an early warning status;
generating an early warning message; and
sending the early warning message to a control terminal.

18. The method of claim 17, further comprising:
obtaining a control command from the control terminal; and
controlling the flight status of the UAV according to the control command.

19. An unmanned aerial vehicle (UAV) control method comprising:
obtaining flight status information of a UAV and flight status information of an aircraft detected by an automatic dependent surveillance-broadcast (ADS-B) receiver carried by the UAV; and
controlling a flight status of the UAV according to the flight status information of the aircraft and the flight status information of the UAV.

20. An unmanned aerial vehicle (UAV), comprising:
a memory storing instructions; and
a processor configured to read the instructions from the memory to:
obtain flight status information of an aircraft detected by an automatic dependent surveillance-broadcast (ADS-B) receiver carried by the UAV;
obtain flight status information of the UAV; and
control a flight status of the UAV according to the flight status information of the aircraft and the flight status information of the UAV.
